(19) United States
(12) Patent Application Publication
(10) Pub. No.: US 2026/0012984 A1
(43) Pub. Date: Jan. 8, 2026

(54) SYSTEM AND METHOD FOR CONNECTIVITY DATA FLOW AND SYNCHRONIZATION IN A NETWORK

(71) Applicant: JIO PLATFORMS LIMITED, Ahmedabad, Gujarat (IN)

(72) Inventors: Sumit GUPTA, Navi Mumbai, Maharashtra (IN); Santosh PINTO, Navi Mumbai, Maharashtra (IN); Aayush BHATNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/992,607

(22) PCT Filed: Mar. 18, 2024
(86) PCT No.: PCT/IN2024/050278

§ 371 Date: Jan. 9, 2025

(30) Foreign Application Priority Data
Mar. 31, 2023 (IN) 202321024795

(51) Int. Cl. H04W 76/10; H04W 16/20; H04W 28/084; H04W 56/00

(52) U.S. Cl. CPC H04W 76/10; H04W 16/20; H04W 28/084; H04W 56/001

(57) ABSTRACT

The present disclosure provides a system and a method for performing connectivity data flow in a network is described. A backhaul router (302) is configured for plurality of virtual local area networks (VLANs) to support indoor small cell (IDSC) connectivity for at least one of mobile network generation by creating a first set of VLANs is created in the backhaul router (302) and a 5G IDSC (300) associated with a first one of mobile network generation signalling/data packets, a second set of VLANs is created in the backhaul router (302) and a 4G IDSC (414) associated with a second one of mobile network generation signalling/data packets and bridging the second set of VLANs is bridged to the 5G IDSC (300) to allow mobile network generation packets of second one of mobile network generation from the backhaul router (302) to the 4G IDSC (414).

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for indoor deployment using fourth-generation (4G) and fifth-generation (5G) networks. More particularly, the present disclosure relates to a system and a method for providing support to a 4G small cell through a 5G small cell that requires only minimal backhaul configuration changes without the requirement of additional time and cost during an implementation of an indoor 5G rollout.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure and not as an admission of the prior art.

Currently fourth generation (4G) indoor small cells (IDSC) are deployed at mass levels for providing services to various users. Therefore, to provide a fifth generation (5G) upgradation, the whole infrastructure associated with the existing 4G IDSC needs to be replaced with a new IDSC which supports both 5G and 4G networks. Massive costs and a high time area are attributed to changes required in a backhaul configuration of the 5G network.

There is, therefore, a need in the art to provide a system and a method that can mitigate the problems associated with the prior arts.

### SUMMARY

In an exemplary embodiment, a method for performing connectivity data flow in a network is described. The method includes configuring a backhaul router for plurality of virtual local area networks (VLANs) to support indoor small cell (IDSC) connectivity for at least one of mobile network generation, by: creating a first set of VLANs in the backhaul router and a first IDSC associated with a first one of mobile network generation signalling/data packet, creating a second set of VLANs in the backhaul router and a second IDSC associated with a second one of mobile network generation signalling/data packets, bridging the second set of VLANs to the first IDSC to allow mobile network generation packets of second one of mobile network generation from the backhaul router to the second IDSC, and performing signalling procedures between the backhaul router, the first IDSC and the second IDSC to enable connectivity data flow for the first one of mobile network generation signalling/data packets in the network.

In some embodiments, configuring the backhaul router further includes creating a third VLAN in the backhaul router and the first IDSC for synchronization, generating a set of VLAN precision time protocol (PTP) packets from a PTP grandmaster associated with the backhaul router, achieving a PTP sync at the first IDSC with the PTP grandmaster, and enabling an interface of the third VLAN to act as a PTP master for a PTP slave associated with the second one of mobile network generation signalling/data packets, wherein PTP packets are generated from the first IDSC towards the second IDSC, wherein the interface of the third VLAN is enabled at daisy chain port.

In some embodiments, the first one of mobile network generation signalling/data packets is associated with a fifth generation (5G) mobile network and the second one of mobile network generation signalling/data packets is associated with is a fourth generation (4G) mobile network.

In some embodiments, configuring the backhaul router further includes converting an existing ethernet port of the backhaul router as an output port for providing a backhaul to the second IDSC.

In some embodiments, configuring the backhaul router further includes providing a network synchronization for the second IDSC through the PTP running the first IDSC.

In some embodiments, configuring the backhaul router further includes modifying a plurality of configuration parameters to perform daisy chain connectivity at the first IDSC and the second IDSC, wherein the plurality of configuration parameters includes VLAN, Master and Slave IPs, PTP packet flow, and PTP profile configuration comprising IEEE 1588v2 default, ITU G.8275.1, and G.8275.2 in the PTP.

In some embodiments, wherein configuring the backhaul router further includes connecting the first IDSC with an existing backhaul of the backhaul router and a daisy chain port in the first IDSC to provide the backhaul to second IDSC.

In another exemplary embodiment, a system for performing connectivity data flow is described. The system includes a backhaul router configured for plurality of virtual local area networks (VLANs) to support indoor small cell (IDSC) connectivity for at least one of mobile network generation, wherein the backhaul router is configured to create a first set of VLANs and a first IDSC associated with a first one of mobile network generation signalling/data packets, create a second set of VLANs in the backhaul router and a second IDSC associated with a second one of mobile network generation signalling/data packets, bridge the second set of VLANs to the first IDSC to allow mobile network generation packets of second one of mobile network generation from the backhaul router to the second IDSC, and perform signalling procedures between the backhaul router, the first IDSC and the second IDSC to enable the connectivity data flow for the first one of mobile network generation signalling/data packets in the network.

In some embodiments, the backhaul router is further configured to: create a third VLAN in the backhaul router and the first IDSC for synchronization, generate a set of VLAN precision time protocol (PTP) packets from a PTP grandmaster associated with the backhaul router, achieve a PTP sync at the first IDSC with the PTP grandmaster, and enable an interface of the third VLAN to act as a PTP master for a PTP slave associated with the second one of mobile network generation signalling/data packets, wherein PTP packets are generated from the first IDSC towards the second IDSC, wherein the interface of the third VLAN is enabled at daisy chain port.

In some embodiments, the first one of mobile network generation signalling/data packets is associated with a fifth generation (5G) mobile network and the second one of mobile network generation signalling/data packets is associated with a fourth generation (4G) mobile network.

In some embodiments, the backhaul router is further configured to convert an existing ethernet port of the backhaul router as an output port for providing a backhaul to the second IDSC.

In some embodiments, the backhaul router is further configured to provide a network synchronization for the second IDSC through the PTP running the first IDSC.

In some embodiments, the backhaul router is further configured to modify a plurality of configuration parameters to perform daisy chain connectivity at the first IDSC and the second IDSC, wherein the plurality of configuration parameters includes VLAN, Master and Slave IPs, PTP packet flow, and PTP profile configuration includes IEEE 1588v2 default, ITU G.8275.1, and G.8275.2 in the PTP.

In some embodiments, a daisy chain port is connected between an ethernet port of the second IDSC and the first IDSC, and a backhaul router port is connected between an optical port of the first IDSC and the backhaul router.

### OBJECTS OF THE INVENTION

It is an object of the present disclosure to provide a system and a method that capitalizes existing fourth generation (4G) infrastructure to be used for both 4G and (5G) fifth generation by implementing minimum backhaul configuration changes without any additional cost and time for an indoor 5G rollout.

It is an object of the present disclosure to provide a system and a method that utilizes a dedicated fifth generation (5G) Ethernet/Optical port in 5G IDSC to connect a 4G indoor small cell (IDSC).

It is an object of the present disclosure to provide a system and a method where a 5G IDSC bridges data, controls PTP signals from a backhaul cell site switch/aggregate node 1 (CSS/AG1) connected to 5G IDSC Optical/Ethernet port and re-routes data to 4G IDSC through dedicated Optical/Ethernet port.

It is an object of the present disclosure to provide a system and a method that provides a fast upgrade to the latest 5G technology by just connecting the 5G IDSC with an existing backhaul and a daisy chain port in the 5G IDSC, hence provides backhaul to the existing 4G IDSC.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system (106), in accordance with an embodiment of the present disclosure.

FIG. 2 illustrates an exemplary representation (200) of a proposed system (106), in accordance with an embodiment of the present disclosure.

FIG. 3 illustrates an exemplary fifth generation (5G) indoor small cell (300), in accordance with an embodiment of the present disclosure.

FIG. 4 illustrates an exemplary block diagram of a 5G indoor small cell (IDSC) with a fourth generation (4G) IDSC (400), in accordance with an embodiment of the present disclosure.

FIG. 5 illustrates an exemplary backhaul architecture (500) of the system (110), in accordance with an embodiment of the present disclosure.

FIG. 6 illustrates an exemplary call flow representation (600) from the 5G IDSC to the 4G IDSC, in accordance with an embodiment of the present disclosure.

FIG. 7 illustrates an exemplary call flow implementation with customized configuration parameters from the 5G IDSC to the 4G IDSC (700), in accordance with an embodiment of the present disclosure.

FIG. 8 illustrates an exemplary clock synchronization mechanism (800), in accordance with an embodiment of the present disclosure.

FIG. 9 illustrates an exemplary call flow implementation (900) of a PTP4L software running in the 5G IDSC for synchronization, in accordance with an embodiment of the present disclosure.

FIG. 10 illustrates an exemplary computer system (1000) in which or with which the proposed system (106) may be implemented, in accordance with an embodiment of the present disclosure.

The foregoing shall be more apparent from the following more detailed description of the disclosure.

### BRIEF DESCRIPTION OF THE INVENTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

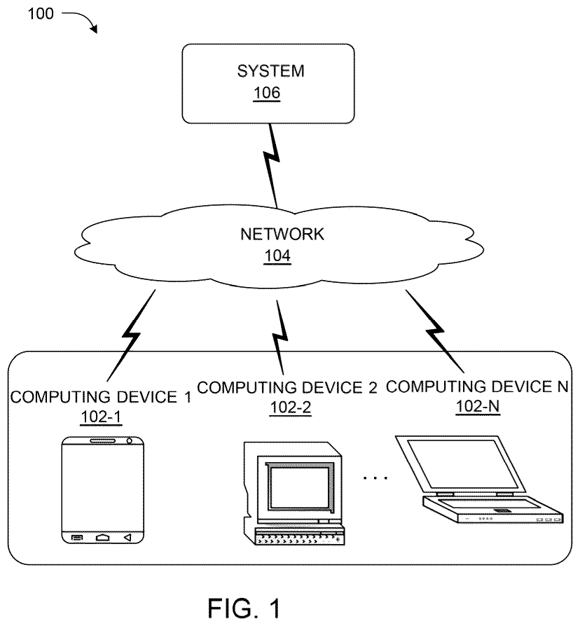

The various embodiments throughout the disclosure will be explained in more detail with reference to FIGS. 1-10.

FIG. 1 illustrates an exemplary network architecture (100) of a proposed system (106), in accordance with an embodiment of the present disclosure. As illustrated in FIG. 1, one or more computing devices (102-1, 102-2 . . . 102-N) may be connected to the proposed system (106) through a network (104). A person of ordinary skill in the art will understand that one or more computing devices (102-1, 102-2 . . . 102-N) may be collectively referred to as computing devices (102) and individually referred to as computing device (102).

In an embodiment, the computing device (102) may include, but not be limited to, a mobile, a laptop, etc. Further, the computing device (102) may include one or more in-built or externally coupled accessories including, but not limited to, a visual aid device such as a camera, audio aid, microphone, or keyboard. Further, the computing device (102) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from a user such as a touchpad, touch-enabled screen, electronic pen, and the like may be used. In an embodiment, users/customers may submit their complaints through the computing devices (102) as shown in FIG. 1.

In an embodiment, the system (106) may include a 5G new radio (NR) with a high-power base station (gNB) which operates in macro class. The system (106) may provide macro-level wide-area solutions for coverage and capacity may be employed in areas with high traffic and higher quality of service (QoS) demands. The system (106) may further include a lower layer PHY section, a radio frequency (RF) transceiver based on commercial grade FPGA/ASICS, multiple RF transmit and receive chains with RF power amplifiers, low noise amplifiers (LNA), RF switches, and an Antenna Filter Unit (AFU).

In an embodiment, the system (106) may receive one or more requests for upgrading an existing network. The existing network may include a fourth generation (4G) network where the system (106) may provide a network synchronization for a 4G indoor small cell (IDSC) via one or more PTP4L running on the system (106).

In an embodiment, the system (106) may be configured with at least an Ethernet port to connect to the 4G IDSC. Further, the system (106) may comprise an optical port to connect to the 4G IDSC.

In an embodiment, the system (106) may be configured to bridge one or more data, control a plurality of PTP signals from a backhaul cell site switch/aggregate node 1 (CSS/AG1) connected to the 5G IDSC Optical/Ethernet port. Further, the system (106) may be configured to re-route one or more data to the 4G IDSC via the optical/Ethernet port. Bridging may include communicatively coupling one or more of the VLANS, IDSCs, etc., that includes synchronizing using PTP, having successful signalling procedures, with cell functioning and configured to attach user equipment for a defined generation of mobile network.

In an embodiment, the system (106) may be configured to vary the backhaul configuration to connect to the 4G IDSC. Further, the system (106) may be configured with a daisy chain port for connecting to the 4G IDSC. For supporting the daisy chain of the 4G IDSC, an existing One Gigabit (1G) Ethernet port may be configured as an output port for providing the required backhaul to the 4G IDSC. All the 4G data, management and synchronization (PTP) signals may be passed from the One Gigabit optical port to the One Gigabit Ethernet port or vice versa.

In an embodiment, the backhaul of the system (106) may be connected to the optical port of the 5G IDSC and the daisy chain output port from the 5G IDSC (Ethernet Port) may be connected to 4G IDSC. Further, backhaul network routers may be configured to support both 5G Core and 4G Core (Control, Data and PTP synchronization) reachability from the IDSC. The required reachability may be established via VLANs (virtual local area networks).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

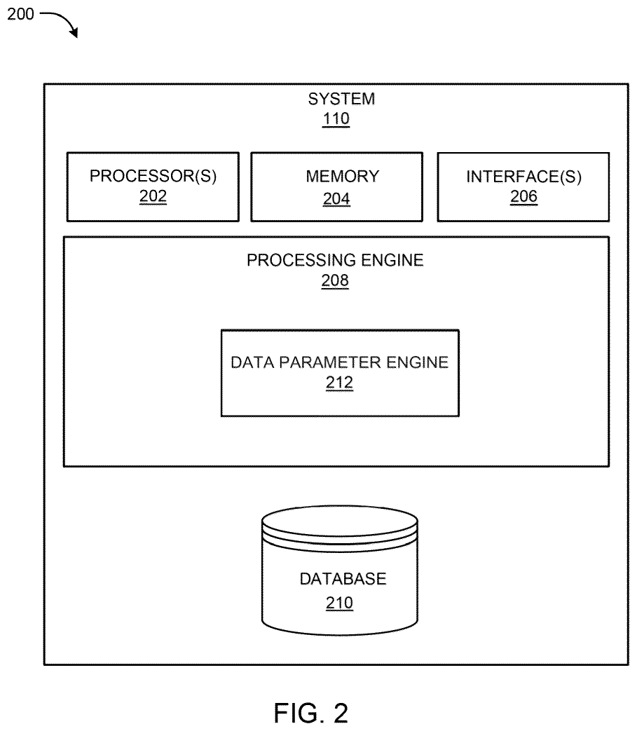

FIG. 2 illustrates an exemplary representation (200) of a proposed system (106), in accordance with an embodiment of the present disclosure.

Referring to FIG. 2, the system (106) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (106). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (106) may include an interface(s) (206). The interface(s) (206) may comprise a variety of interfaces, for example, interfaces for data input and output devices (I/O), storage devices, and the like. The interface(s) (206) may facilitate communication through the system (110). The interface(s) (206) may also provide a communication pathway for one or more components of the system (110). Examples of such components include, but are not limited to, processing engine(s) (208), a database (210), and a data parameter engine (212).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may receive one or more requests for upgrading an existing network via the data parameter engine (212). The existing network may include a fourth-generation (4G) network, where the processor (202) may provide a network synchronization for a 4G indoor small cell (IDSC) via PTP4L.

In an embodiment, the processor (202) may be configured with at least an Ethernet port to connect to the 4G IDSC. Further, the processor (202) may comprise an optical port to connect to the 4G IDSC.

In an embodiment, the processor (202) may be configured to bridge one or more data, control a plurality of PTP signals from a backhaul cell site switch/aggregate node 1 (CSS/AG1) connected to the 5G IDSC Optical/Ethernet port. Further, the processor (202) may be configured to re-route the one or more data to the 4G IDSC through via the optical/Ethernet port.

In an embodiment, the processor (202) may be configured to vary the backhaul configuration to connect to the 4G IDSC. Further, the processor (202) may be configured with a daisy chain port for connecting to the 4G IDSC.

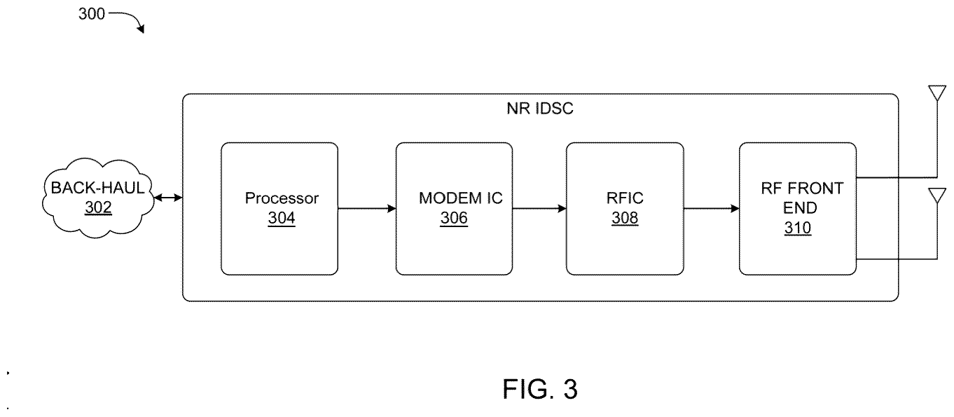

FIG. 3 illustrates an exemplary fifth generation (5G) indoor small cell (300), in accordance with an embodiment of the present disclosure.

As illustrated in FIG. 3, the system (106) may include the 5G NR IDSC with two transmitters and two receivers (2T2R) and a single gNB that supports Sub6 (3.3-3.6 GHz) band n78. The system may be further operated via the backhaul (302) for connecting to the 4G IDSC.

In an embodiment, the system (106) may include a network processor unit (NPU) (304). The NPU (304) may further include packet processing acceleration via high-speed peripherals.

In an embodiment, the system (106) may include a 5G modem unit (306) which provides 5G NR standard for sub-6 Gigahertz (GHz). The 5G modem unit (306) may support peripheral component interconnect express (PCIe) generation 3, x2 lanes with PCIe boot for communication with the NPU (304). Further, the 5G modem unit (306) may support an interface for communication with the sub 6 GHz RFIC. The 5G modem unit (306) may be designed to operate on a third-generation partnership project (3GPP) n78 band.

In an embodiment, the system (106) may include a RF transceiver (308) to support the 5G NR sub-6 GHz. The RF transceiver (308) may communicate with the 5G modem unit (306) through an interface.

In an embodiment, the system (106) may include a front-end unit (310) based on the discrete solutions consisting of a power amplifier, a filter, a circulator, and a switch in the RF path.

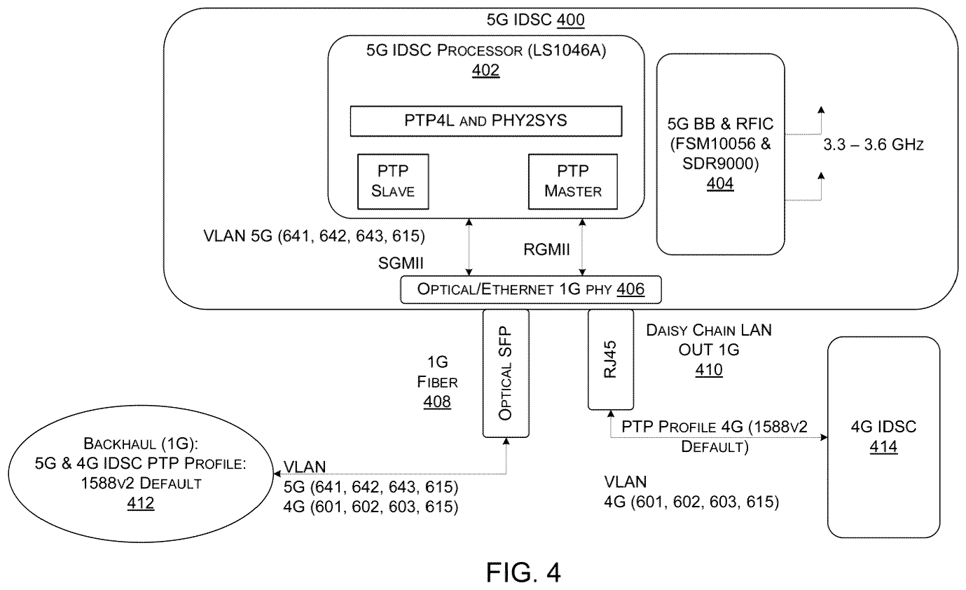

FIG. 4 illustrates an exemplary block diagram of a 5G indoor small cell (IDSC) (400) with a fourth generation (4G) IDSC (414), in accordance with an embodiment of the present disclosure.

As illustrated in FIG. 4, the 5G IDSC processor (402) may include the PTP4L with a PTP master and a PTP slave configuration. The 5G IDSC processor (202) may also be connected to a 5G broadband (BB) and a radio frequency integrated circuit (RFIC) (404) in a range of 3.3 to 3.6 GHz. The 5G IDSC processor (402) may be connected to the One Gigabit optical/Ethernet port (406) via a serial gigabit media-independent interface (SGMII) and a reduced gigabit media-independent interface (RGMII). Further, the optical/Ethernet port (406) may be connected to the One Gigabit backhaul 5G and 4G IDSC (412) via an optical small form-factor pluggable (SFP). The backhaul (412) is connected to 5G IDSC (400) via 1G fiber (408). The 1G fiber (408) may be backhaul router port. Also, the optical/Ethernet port (406) may be connected to the 4G IDSC (414) via the daisy chain port (410). In an aspect, 1G fiber is a cable having a maximum data transfer rate of 1 gigabit per second (Gbps). One Gigabit optical/Ethernet port is a port for transmitting ethernet frames at a rate of a gigabit per second.

In an embodiment, the 5G IDSC (402) may include two backhaul options that may include but not limited to a 1 Gbps Ethernet port and a 1 Gbps Optical port. For supporting the daisy chain of the 4G Indoor small cell, the existing One Gigabit Ethernet port may be converted as an output port for backhaul to the 4G IDSC. Further, backhaul network routers may be configured to support both 5G Core and 4G Core (Control, Data and PTP synchronization) reachability from the IDSC.

As illustrated in FIGS. 4, 641, 642 and 643 VLAN identifications (IDs) may be used for the 5G core connectivity, while 601, 602 and 603 VLAN IDs may be used for the 4G core connectivity. In fact, VLAN IDs may be defined and configured in 5G IDSC based on the requirement of existing backhaul and the 4G IDSC. In an example, the 641, 642 and 643 VLAN identifications are first set of VLANs created in the backhaul router. In an example, the 601, 602 and 603 VLAN identifications are second set of VLANs created in the backhaul router.

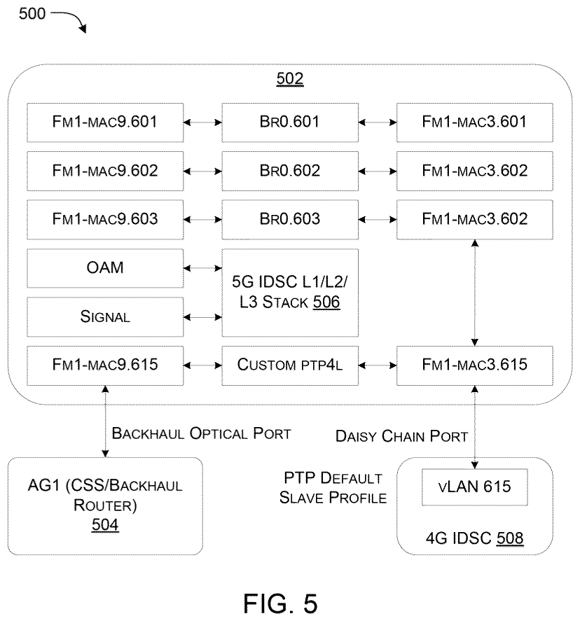

FIG. 5 illustrates an exemplary backhaul architecture (500) of the system (110), in accordance with an embodiment of the present disclosure.

As illustrated in FIG. 5, 5G IDSC (506) may be connected to an AG1 (CSS/backhaul router) (504) via the backhaul optical port. A 5G IDSC unit (502) includes the 5G IDSC (506), ethernet operations, administration and management (OAM) unit, signal unit and various port such as the fm1-mac. Further, 5G IDSC (506) may be connected to the 4G IDSC (508) via the daisy chain port. The daisy chain port is connected between an ethernet port of the second IDSC and the first IDSC, and a backhaul router port is connected between an optical port of the first IDSC and the backhaul router.

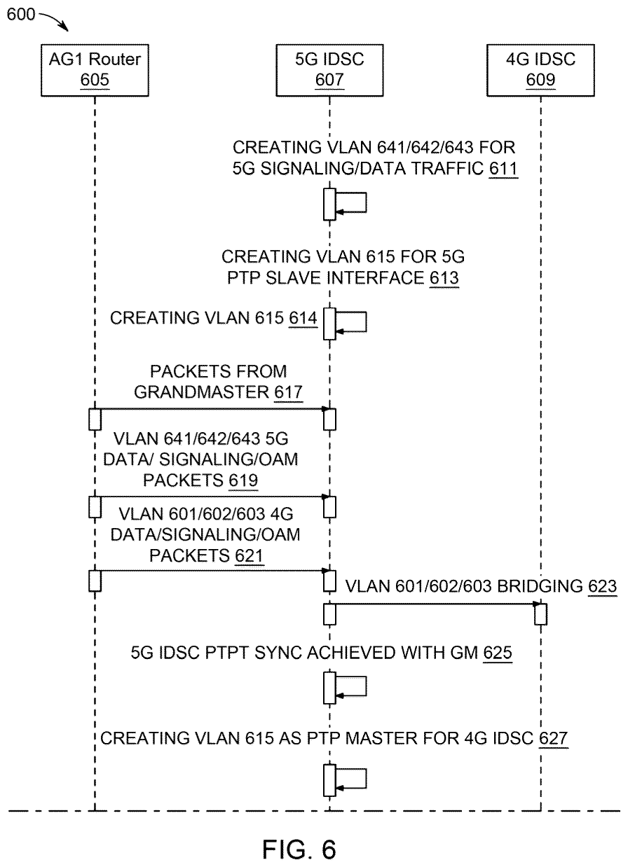

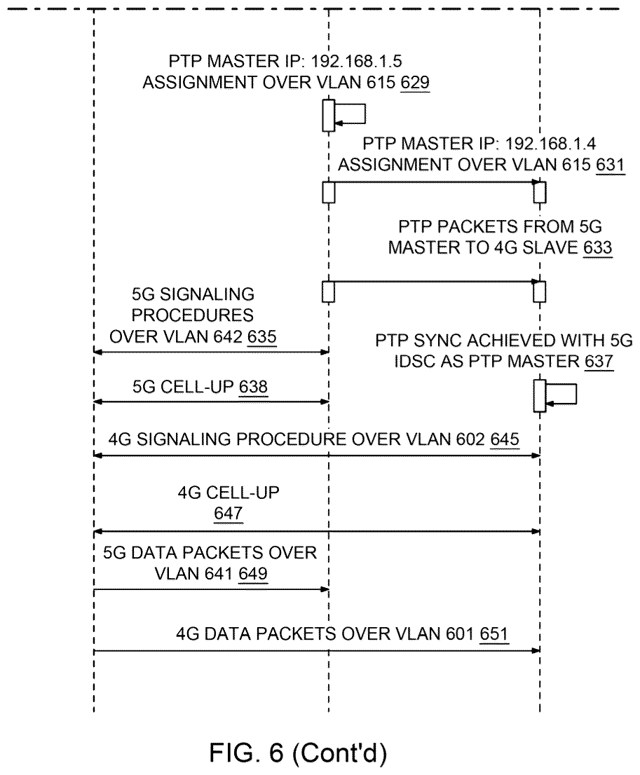

FIG. 6 illustrates an exemplary call flow representation (600) from the 5G IDSC to the 4G IDSC, in accordance with an embodiment of the present disclosure.

As illustrated in FIG. 6, the following steps may be utilized during the call flow representation (600).

At step 611: The VLAN 641/642/643 may be created in the backhaul router (605) and the 5G IDSC (607) for 5G signalling/data packets may be consumed. In an example, the 641, 642 and 643 VLAN identifications are a first set of VLANs created in the backhaul router.

The VLAN 601/602/603 may be created in the backhaul router (605) and the 4G IDSC (609) for 4G signalling/data packets may be consumed. In an example, the 601, 602 and 603 VLAN identifications are a second set of VLANs created in the backhaul router.

At step 613: The VLAN 615 may be created for 5G PTP SLAVE interface. In an example, the VLAN 615 may be a third VLAN.

At step 614: The 5G IDSC (607) may create VLAN 615. In an example, VLAN 615 is a third VLAN.

At step 617: PTP grandmaster associated with the AG1 router may generate VLAN 615 packets and send them to the 5G IDSC (607). The grandmaster refers to a network node that serves as the primary time reference in a PTP-based synchronization network. In examples, PTP is a protocol used to synchronize clocks in a distributed system with high precision, often in applications where accurate timekeeping is crucial, such as in telecommunications.

At step 619: 5G Data signalling packets may be sent from the AG1 router (602) to the 5G IDSC (607).

At step 621: 4G Data signalling packets may be sent from the AG1 router (602) to the 5G IDSC (607).

At step 623: 5G IDSC (607) may generate VLAN 601/602/603 bridging to the 4G IDSC (609).

At step 625: 5G IDSC (607) PTP synchronization may be achieved with a grandmaster (GM).

At step 627: 5G IDSC (607) may generate VLAN 615 (third VLAN) as PTP master for 4G IDSC (609).

At step 629: 5G IDSC (607) may generate PTP master over VLAN 615. For example, PTP Master IP: 192.168.1.5 (configurable) is given to VLAN 615 Master interface.

At step 631: 5G IDSC (607) may send PTP master assignment over VLAN (615) to the 4G IDSC (609). For example, PTP Slave IP: 192.168.1.4 (Configurable) is given to the VLAN 615 on the 4G IDSC interface.

At step 633: 5G IDSC (607) may send PTP packets from 5G master to the 4Gslave.

At step 635: 5G signalling procedures may be performed over VLAN from the AG1 router (605) to the 5G IDSC (607). Also, the 5G signalling procedures may be sent from the 5G IDSC (607) to the AG1 router (605).

At step 637: PTP synchronization may be achieved with 5G IDSC (607). In examples, as per PTP protocol message flow, the PTP sync is achieved at the 4G IDSC (609) end.

At step 638: 5G cell up may be generated across the AG 1 router (605) and the 5G IDSC (607).

At step 645: 4G signalling procedure over VLAN may be transmitted from the AG 1 router (605) to the 4G IDSC (609).

At step 647: 4G cell up may be generated across the AG 1 router (605), the 4G IDSC (609).

At step 649: 5G data packets may be transmitted from the AG 1 router (605) to the 5G IDSC (607).

At step 651: 4G data packets over VLAN 601 may be transmitted from the AG 1 router (605) to the 4G IDSC (609).

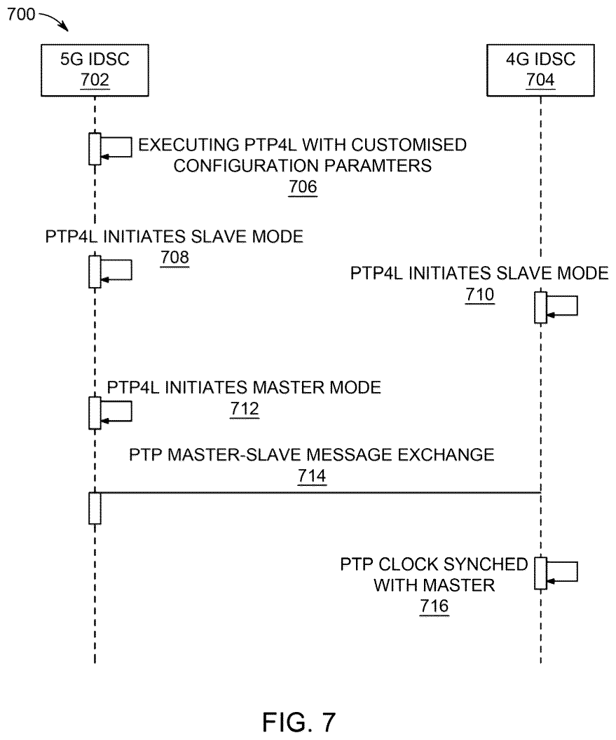

FIG. 7 illustrates an exemplary call flow implementation with customized configuration parameters from the 5G IDSC to the 4G IDSC (700), in accordance with an embodiment of the present disclosure.

As illustrated in FIG. 7, in an embodiment, one or more customized certain configuration parameters may be utilized by the system (106) in order to trigger PTP4L software to function both as the PTP Slave for 5G IDSC (702) and the PTP Master for 4G IDSC (704). The configuration parameters comprise VLAN, Master and Slave IPs, PTP packet flow, PTP profile configuration (including IEEE 1588v2 default, ITU G.8275.1, G.8275.2) in the PTP.

The following steps may be utilized by the system (106).

At step 706: The PTP4L binary may be executed with customized configuration parameters to act as slave for the Grandmaster and master for the 4G IDSC (704).

At step 708: The PTP4L may functions with the slave behaviour by trying to synchronize the local 5G clock with the PTP packets coming from the PTP Grandmaster.

At step 710: In parallel, the 4G IDSC (704) may also starts the PTP4L binary in the slave mode and may wait in a listening mode to the PTP packets arriving from the 5G IDSC (702).

At step 712: On 5G IDSC (702), due to the customization commands set, the PTP4L may also start the master mode for the 4G IDSC (704).

At step 714: The PTP message exchange between the master and slave processes may be set resulting in an establishment of the PTP master-slave communication.

At step 716: Due to above PTP establishment, the local clock on the 4G IDSC (704) may enter into the PTP synchronization state.

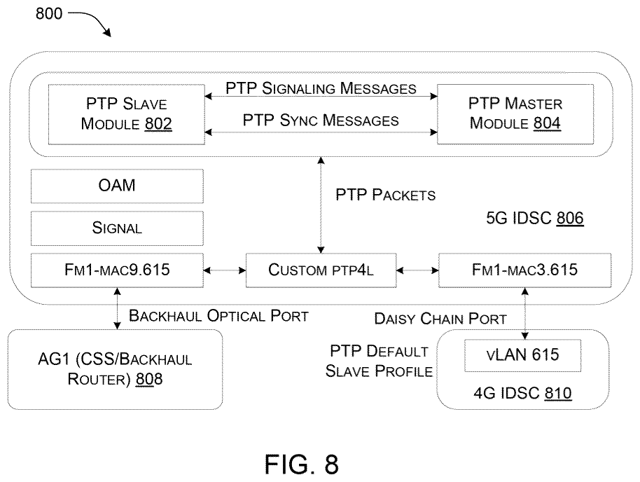

FIG. 8 illustrates an exemplary clock synchronization mechanism (800), in accordance with an embodiment of the present disclosure.

As illustrated in FIG. 8, network synchronization of the 5G IDSC (806) may deal with the distribution of time and frequency across a network of clocks often spread over a wide geographical area. Alignment of (i.e., synchronize) the time and frequency scales of all network elements clocks may be required. The 5G IDSC (806) may utilize the PTP profile IEEE 1588v2. Further, in an embodiment, the system (106) may include implementation of the PTP using PTP4L software running in 5G IDSC (806) for synchronization of itself and the daisy chain 4G IDSC (810).

Further, in an embodiment, the PTP grandmaster running in the network may be connected to 5G IDSC (806) over the backhaul port (same port used for data, signalling, and operations, administration, and maintenance (OAM). The PTP4L software running in 5G IDSC (806) may decode it (in slave mode) and provide the synchronization to the 5G IDSC (806). The PTP4L software may be modified such that the PTP4L acts as PTP master and provides the synchronization packets to the 4G IDSC (810).

As illustrated in FIG. 8, the clock synchronization mechanism (800) may include communication between the PTP slave module (802) and the PTP master module (804) via the PTP signalling messages and the PTP sync messages. Further, the 5G IDSC (806) may utilize the backhaul optical port to connect to the AG1 (808) (CSS/backhaul router). The 5G IDSC (806) may utilize the daisy chain port to connect to the 4G IDSC (810).

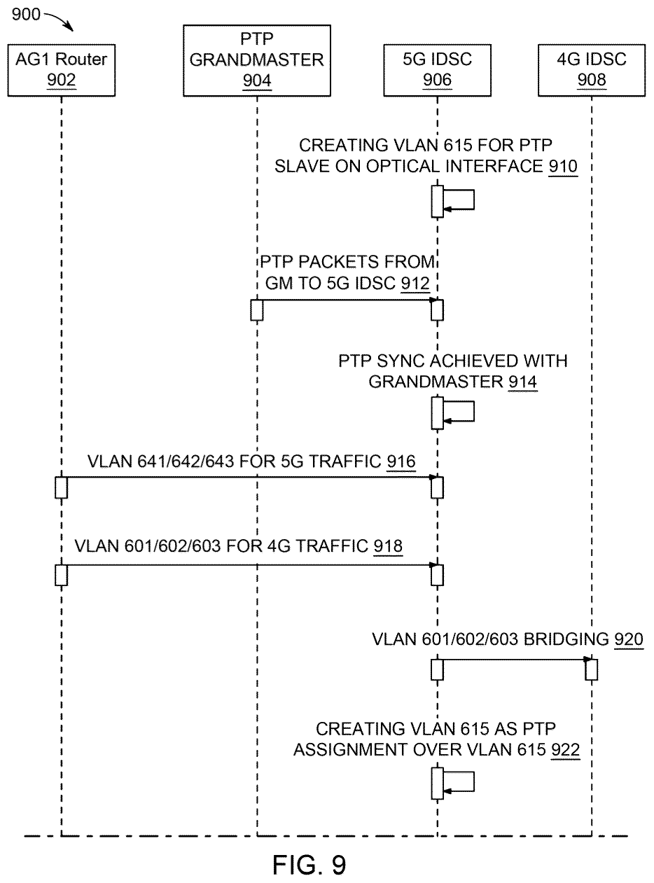

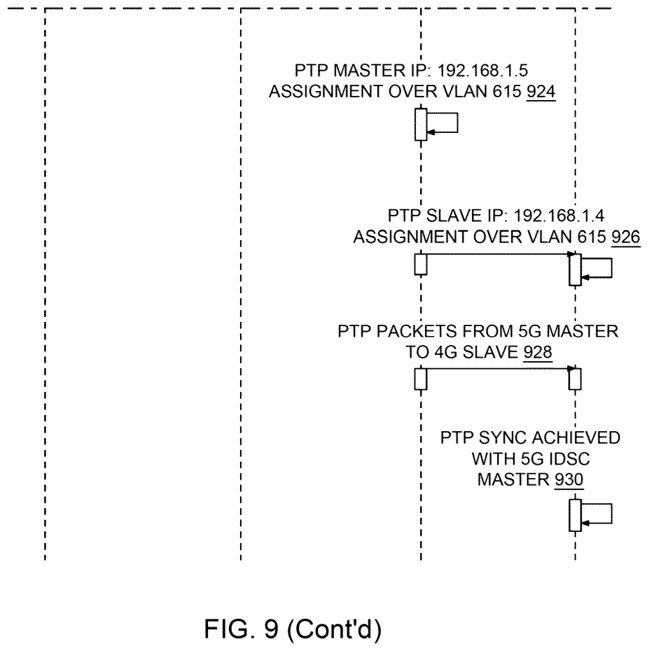

FIG. 9 illustrates an exemplary call flow implementation (900) of a using PTP4L software running in the 5G IDSC for synchronization, in accordance with an embodiment of the present disclosure.

The following steps may be utilized for the call flow implementation (900)

At step 910: The 5G IDSC (906) may create VLAN 615 for PTP slave on the optical interface.

At step 912: The PTP grandmaster (904) may send PTP packets from a grandmaster (GM) to 5G IDSC (906).

At step 914: PTP synchronization may be achieved with the Grandmaster in the 5G IDSC (906).

At step 916: VLAN 641/642/643 for 5G traffic may be sent from the AG1 router (902) to the 5G IDSC (906).

At step 918: VLAN 601/602/603 for 4G traffic may be sent from the AG1 router (902) to the 5G IDSC (906).

At step 920: Bridging may be provided from the 5G IDSC (906) to the 4G IDSC (908).

At step 922: The 5G IDSC (906) may create VLAN 615 as PTP master for the 4G IDSC (908).

At step 924: The 5G IDSC (906) may generate a PTP master internet protocol (IP) over VLAN 615.

At step 926: The 5G IDSC (906) may send an assignment over VLAN 615 to the 4G IDSC (908).

At step 928: The 5G IDSC (906) may send PTP packets from the 5G master to the 4G slave.

At step 930: The 4G IDSC (908) may generate the PTP synchronization with the 5G IDSC (906) master.

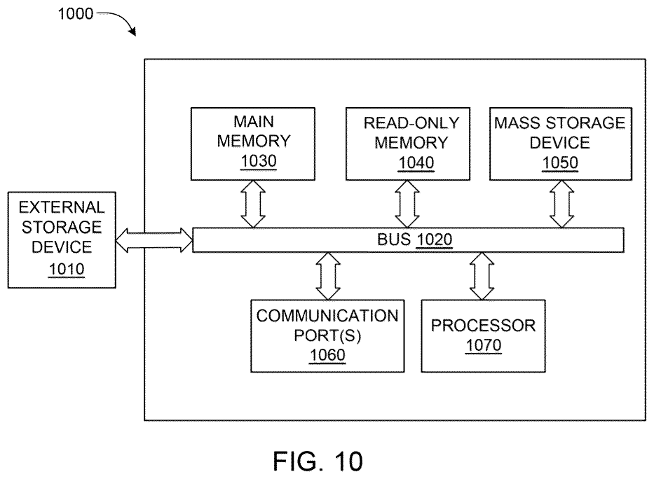

FIG. 10 illustrates an exemplary computer system (1000) in which or with which the proposed system (106) may be implemented, in accordance with an embodiment of the present disclosure.

As shown in FIG. 10, the computer system (1000) may include an external storage device (1010), a bus (1020), a main memory (1030), a read-only memory (1040), a mass storage device (1050), a communication port(s) (1060), and a processor (1070). A person skilled in the art will appreciate that the computer system (1000) may include more than one processor and communication ports. The processor (1070) may include various modules associated with embodiments of the present disclosure. The communication port(s) (1060) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (1060) may be chosen depending on a network, such as a Local Area Network (LAN), Wide Area Network (WAN), or any network to which the computer system (1000) connects.

In an embodiment, the main memory (1030) may be Random Access Memory (RAM), or any other dynamic storage device commonly known in the art. The read-only memory (1040) may be any static storage device(s) e.g., but not limited to, a Programmable Read Only Memory (PROM) chip for storing static information e.g., start-up or basic input/output system (BIOS) instructions for the processor (1070). The mass storage device (1050) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (1020) may communicatively couple the processor(s) (1070) with the other memory, storage, and communication blocks. The bus (1020) may be, e.g., a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (1070) to the computer system (1000).

In another embodiment, operator and administrative interfaces, e.g., a display, keyboard, and cursor control device may also be coupled to the bus (1020) to support direct operator interaction with the computer system (1000). Other operator and administrative interfaces can be provided through network connections connected through the communication port(s) (1060). Components described above are meant only to exemplify various possibilities. In no way should the aforementioned exemplary computer system (1000) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that utilizes an indoor fifth generation (5G) rollout on an existing fourth generation (4G) indoor infrastructure without any major changes in 4G indoor small cell (IDSC) backhaul connectivity configuration.

The present disclosure provides a system and a method where 5G and 4G services will be delivered simultaneously with minimal configuration changes in the backhaul infrastructure.

The present disclosure provides a system and a method 5G IDSC provides the network synchronization for 4G IDSC through single PTP4L running the 5G IDSC.

The present disclosure provides a system and a method that capitalizes existing fourth generation (4G) infrastructure to be used for both 4G and (5G) fifth generation by implementing minimum backhaul configuration changes without any additional cost and time for an indoor 5G rollout.

The present disclosure provides a system and a method that utilizes a dedicated fifth generation (5G) Ethernet/Optical port in 5G IDSC to connect a 4G indoor small cell (IDSC).

The present disclosure provides a system and a method where a 5G IDSC bridges data, controls PTP signals from a backhaul cell site switch/aggregate node 1 (CSS/AG1) connected to 5G IDSC Optical/Ethernet port and re-routes data to 4G IDSC through dedicated Optical/Ethernet port.

The present disclosure provides a system and a method that provides a fast upgrade to the latest 5G technology by just connecting the 5G IDSC with an existing backhaul and a daisy chain port in the 5G IDSC, hence provides backhaul to the existing 4G IDSC.

The present disclosure provides a system and method that optimizes the cost of communication infrastructure.

The present disclosure provides a system and method that implements reusability and enhancements with the presently available facilities.

We claim:

1. A method for performing connectivity data flow in a network, the method comprising:
configuring a backhaul router (302, 412, 504) for plurality of virtual local area networks (VLANs) to support indoor small cell (IDSC) connectivity for at least one of mobile network generation, by:
creating a first set of VLANs in the backhaul router (302, 412, 504) and a first IDSC associated with a first one of mobile network generation signalling/data packets;
creating a second set of VLANs in the backhaul router (302, 412, 504) and a second IDSC associated with a second one of mobile network generation signalling/data packets;
bridging the second set of VLANs to the first IDSC to allow mobile network generation packets of second one of mobile network generation from the backhaul router (302, 412, 504) to the second IDSC; and
performing signalling procedures between the backhaul router (302, 412, 504), the first IDSC and the second IDSC to enable connectivity data flow for the first one of mobile network generation signalling/data packets in the network.

2. The method claimed as claim 1, wherein configuring the backhaul router (302, 412, 504) further comprising:
creating a third VLAN in the backhaul router (302, 412, 504) and the first IDSC for synchronization;
generating a set of VLAN precision time protocol (PTP) packets from a PTP grandmaster associated with the backhaul router (302, 412, 504);
achieving a PTP sync at the first IDSC with the PTP grandmaster; and
enabling an interface of the third VLAN to act as a PTP master for a PTP slave associated with the second one of mobile network generation signalling/data packets, wherein PTP packets are generated from the first IDSC towards the second IDSC, wherein the interface of the third VLAN is enabled at a daisy chain port (410).

3. The method claimed as claim 1, wherein the first one of mobile network generation signalling/data packets is associated with a fifth generation (5G) mobile network and the second one of mobile network generation signalling/data packets is associated with is a fourth generation (4G) mobile network.

4. The method claimed as claim 2, wherein configuring the backhaul router (302, 412, 504) further comprising: converting an existing ethernet port of the backhaul router (302, 412, 504) as an output port for providing a backhaul to the second IDSC.

5. The method claimed as claim 2, wherein configuring the backhaul router (302, 412, 504) further comprising: providing a network synchronization for the second IDSC through the PTP running the first IDSC.

6. The method claimed as claim 1, wherein configuring the backhaul router (302, 412, 504) further comprising:
modifying a plurality of configuration parameters to perform daisy chain connectivity at the first IDSC and the second IDSC, wherein the plurality of configuration parameters comprises VLAN, Master and Slave IPs, PTP packet flow, and PTP profile configuration comprising IEEE 1588v2 default, ITU G.8275.1, and G.8275.2 in the PTP.

7. The method claimed as claim 1, wherein configuring the backhaul router (302, 412, 504) further comprising:
connecting the first IDSC with an existing backhaul of the backhaul router (302, 412, 504) and the daisy chain port (410) in the first IDSC to provide the backhaul to second IDSC.

8. A system for performing connectivity data flow in a network comprising:
a backhaul router (302, 412, 504) configured for plurality of virtual local area networks (VLANs) to support indoor small cell (IDSC) connectivity for at least one of mobile network generation, wherein the backhaul router (302, 412, 504) is configured to:
create a first set of VLANs and a first IDSC associated with a first one of mobile network generation signalling/data packets;
create a second set of VLANs in the backhaul router (302, 412, 504) and a second IDSC associated with a second one of mobile network generation signalling/data packets;
bridge the second set of VLANs to the first IDSC to allow mobile network generation packets of second one of mobile network generation from the backhaul router (302, 412, 504) to the second IDSC; and
perform signalling procedures between the backhaul router (302, 412, 504), the first IDSC and the second IDSC to enable the connectivity data flow for the first one of mobile network generation signalling/data packets in the network.

9. The system claimed as in claim 8, wherein the backhaul router (302, 412, 504) is further configured to:
create a third VLAN in the backhaul router (302, 412, 504) and the first IDSC for synchronization;
generate a set of VLAN precision time protocol (PTP) packets from a PTP grandmaster associated with the backhaul router (302, 412, 504);
achieve a PTP sync at the first IDSC with the PTP grandmaster; and
enable an interface of the third VLAN to act as a PTP master for a PTP slave associated with the second one of mobile network generation signalling/data packets, wherein PTP packets are generated from the first IDSC towards the second IDSC, wherein the interface of the third VLAN is enabled at daisy chain port.

10. The system claimed as in claim 8, wherein the first one of mobile network generation signalling/data packets is associated with a fifth generation (5G) mobile network and the second one of mobile network generation signalling/data packets is associated with a fourth generation (4G) mobile network.

11. The system claimed as in claim 8, wherein the backhaul router (302, 412, 504) is further configured to convert an existing ethernet port of the backhaul router as an output port for providing a backhaul to the second IDSC.

12. The system claimed as in claim 8, wherein the backhaul router (302, 412, 504) is further configured to provide a network synchronization for the second IDSC through the PTP running the first IDSC.

13. The system claimed as in claim 8, wherein the backhaul router (302, 412, 504) is further configured to modify a plurality of configuration parameters to perform daisy chain connectivity at the first IDSC and the second IDSC, wherein the plurality of configuration parameters comprises VLAN, Master and Slave IPs, PTP packet flow, and PTP profile configuration comprising IEEE 1588v2 default, ITU G.8275.1, and G.8275.2 in the PTP.

14. The system claimed as claim 13, wherein:
a daisy chain port (410) is connected between an ethernet port of the second IDSC and the first IDSC; and
a backhaul router port (408) is connected between an optical port of the first IDSC and the backhaul router (302, 412, 504).

15. A computer program product comprising a non-transitory computer-readable medium comprising instructions that, when executed by one or more processors, cause the one or more processors to:
configure a backhaul router (302, 412, 504) for plurality of virtual local area networks (VLANs) to support indoor small cell (IDSC) connectivity for at least one of mobile network generation, by:
create a first set of VLANs in the backhaul router (302, 412, 504) and a first IDSC associated with a first one of mobile network generation signalling/data packets;
create a second set of VLANs in the backhaul router (302, 412, 504) and a second IDSC associated with a second one of mobile network generation signalling/data packets;
bridge the second set of VLANs to the first IDSC to allow mobile network generation packets of second one of mobile network generation from the backhaul router (302, 412, 504) to the second IDSC; and
perform signalling procedures between the backhaul router (302, 412, 504), the first IDSC and the second IDSC to enable connectivity data flow for the first one of mobile network generation signalling/data packets in the network.
